(19) United States
(12) Patent Application Publication
(10) Pub. No.: US 2002/0102345 A1
(43) Pub. Date: Aug. 1, 2002

(54) Non-Alcoholic beer composition wih energy enhancing characteristics and method for making the same

(75) Inventor: Hernando Ramirez, Miami, FL (US)

Correspondence Address: C. DOUGLAS McDONALD, CARLTON FIELDS, P.A., P. O. BOX 3239, TAMPA, FL, 33601-3239, US

(73) Assignee: International Brewery Business Incorporated

(21) Appl. No.: 09/770,545

(22) Filed: Jan. 26, 2001

(51) Int. Cl. C12C 1/00

(52) U.S. Cl. 426/590

(57) ABSTRACT

A non-alcoholic beer composition capable of providing increased energy is provided as well as a method for making the same. The composition of the present invention includes a base composition including non-alcoholic beer. Further included is an energy-enhancing ingredient mixed with the base composition for providing increased energy.

### FIELD OF THE INVENTION

The present invention relates to non-alcoholic malt beverages, and more particularly to enhancing a non-alcoholic beer composition.

### BACKGROUND OF THE INVENTION

Alcoholic beverages are an important class of consumer goods. Recently, a trend toward beverages of lower alcohol content has developed due, in part, to the public's increasing health-consciousness and the social and legislative initiatives against drunk driving. Changes in demographics and consumer preferences have also led to contraction in certain segments of the liquor and spirits business.

In response, makers of alcoholic beverages have introduced low-alcohol beers and wines to the market. These products are made either by altering the fermentation process to generate less ethanol, or by processing conventionally made beverages to remove part of their alcohol content.

This same increase in the public's health-consciousness has made health and energy drinks more popular. Demand for such products has been evidenced by the growth in the number of stores dedicated solely to the sale of these types of drinks. Examples of such health and energy drinks are as follows:

Prinkkila in U.S. Pat. No. 4,853,237 teaches a fitness drink powder containing glucose polymer, various salts and fruit acid. The drink composition of Prinkkila is designed to be available to the body in an optimum manner. In addition, the drink product is designed to maintain a high sugar concentration in the blood during physical exertion.

In U.S. Pat. No. 5,032,411 Stray-Gunderson discloses a hypotonic beverage with essential electrolytes, minerals and carbohydrates. Because the beverage composition is hypotonic, the stomach empties very rapidly and the composition can produce a beneficial physiologic response.

Kahm in U.S. Pat. No. 4,042,684 discloses a dietetic beverage containing sugar and essential salts. The composition is said to enhance energy stores. In addition, the composition does not require preservatives. The mixture of glucose and fructose used in the composition produces rapid transport of glucose out of the digestive system while fructose is more slowly transported out of the system.

A flavored and sweetened aqueous dietetic beverage used to rehydrate the body is shown by Boyle in U.S. Pat. No. 4,874,606. L-aspartyl-L-phenyl-alanine methyl ester is included in the beverage to increase the degree of gastric emptying.

Santus et al in U.S. Pat. No. 5,405,619 teaches controlled release therapeutic systems for liquid pharmaceutical formulations. The patent discloses coated microgrannules which allow for suspension of the coated granules in the liquid vehicle.

In U.S. Pat. No. 5,417,982, Modi discloses polymer coated microspheres which are resistant to enzymatic degradation.

Rudaic in U.S. Pat. No. 5,430,021 teaches drugs incorporated into hydrophobic particles. Disclosed are various protective and sustained release coatings.

There is thus a need for addressing the need for non-alcoholic beer and health/energy drinks with a single composition.

### DISCLOSURE OF THE INVENTION

A non-alcoholic beer composition capable of providing increased energy is provided as well as a method for making the same. The composition of the present invention includes a base composition including non-alcoholic beer. Further included is an energy-enhancing ingredient mixed with the base composition for providing increased energy.

In one embodiment of the present invention, the energy-enhancing ingredient may include an alkaloid. Such alkaloid may include caffeine.

In another embodiment of the present invention, the energy-enhancing ingredient may include an aminoacid such as L-phenylalanine, taurine, or the like. Still yet, the energy-enhancing ingredient may include ginseng, herbs, vitamins, minerals, or the like for enhancing the non-alcoholic beer base composition.

### BRIEF DESCRIPTION OF THE DRAWINGS

FIG. 1 is a schematic representation of the basic membrane extraction process, in accordance with one embodiment of the present invention;

FIG. 2 is a schematic representation of the basic pervaporation process for the removal of ethanol from alcoholic beverages wherein the water activity is equalized in the liquid phase and gaseous phase by addition of water vapor to the gaseous phase;

FIG. 3 shows a plot of the activity coefficient of water as a function of mole % ethanol in the liquid phase;

FIG. 4 shows a plot of the relative humidity required to prevent water transport across the membrane as a function of mole % ethanol in the liquid phase;

FIG. 5 shows a plot of the relative humidity required to prevent water transport across the membrane as a function of volume % ethanol in the liquid phase;

FIG. 6 is a schematic representation of a vapor-swept pervaporation process with feed- and permeate-side water activity equalization and ethanol recovery;

FIG. 7 shows a schematic representation of a process whereby liquid water entering a gas-liquid contactor is vaporized into a non-condensable gas;

FIG. 8 shows a schematic representation of a process whereby an excess of steam is mixed with the noncondensable gas in a condenser to produce a water-saturated exit gas stream;

FIG. 9 is a schematic representation of a process which combines the humidification and ethanol recovery subsystems in the form of a gas-liquid contactor;

FIG. 10 shows a bench-scale apparatus for pervaporation removal of ethanol from beverages using a vapor-swept system;

FIG. 11 is a schematic representation of a prevaporation system with permeate removal by vacuum and permeate-side water activity control; and

FIG. 12 illustrates a composition capable of providing increased energy, in accordance with one embodiment of the present invention.

### DESCRIPTION OF THE PREFERRED EMBODIMENTS

Preferred Base Composition Embodiments

The present invention includes as a base composition of any desired fluid. For example, water, juice, malt beverage (i.e. beer), or the like may be employed. It should be noted, however, that any desired base composition may be utilized per the desires of the user.

In one embodiment, a non-alcoholic beer may be utilized. Such base composition may be generated using any desired method. Various exemplary methods will now be set forth.

Solvent Extraction Methods

Conventional solvent extraction technology has long been applied to the recovery of ethanol from aqueous solutions in industry (Schiebel, 1950, Industrial & Engineering Chemistry 42: 1497-1508). This technology, however, is not directly applicable to the production of low-alcohol wines or other beverages. There would invariably be excessive solubility of the extraction solvent in the wine and, hence, contamination. Emulsification and physical entrainment might also occur (Hartline, 1979, Science 206: 41-42). Furthermore, with most extraction solvents it would be expected that numerous other organic constituents of the wine would be coextracted with the ethanol, thereby creating a wholly unacceptable product.

Membrane solvent extraction, in which a membrane is interposed between a solvent containing a solute to be extracted and a second, immiscible extraction solvent, prevents the solvent entrainment and emulsion formation problems inherent to conventional solvent extraction technology. For example, Kim, in the U.S. Pat. No. 4,443,414, used a microporous membrane to extract molybdenum from solutions containing molybdenum and other mineral ions. Lee et al., in U.S. Pat. No. 3,956,112, described a membrane solvent extraction system for general application based upon the use of a non-porous membrane. The membrane was solvent-swollen, so that one of two substantially immiscible liquids which the membrane separated caused the membrane to swell, forming an intermediary zone through which diffusion of solute material could occur. Ho et al., in U.S. Pat. No. 3,957,504, used an ion-exchange membrane in the manner of Lee et al., to recover metal ions from an aqueous solution.

Pressure-Driven Methods

Pressure-driven membrane processes operating at ambient or sub-ambient temperatures may remove excessive quantities of water and concentrate the alcoholic beverage in the process. In reverse osmosis, for example, alcohol removal is achieved by simultaneous removal of ethanol and water by pressurizing the beverage against a membrane with limited ethanol/water selectivity (Bui et al., 1986, Am. J. Enol. Vitic, 37: 297 and Light et al., 1985, AlChE Symp. Ser. 250, No. 82, Recent Advances in Separation Techniques and Light, U.S. Pat. No. 4,617,127, issued October, 1986). To compensate for the water loss, the beverage may be diluted with water prior to alcohol reduction, or water could be added to the concentrated product after processing to replace the volume originally occupied by ethanol and water. Either approach would involve exchanging part or most of the native water contained in the beverage. Loss of volatile flavor components is frequently observed when water is removed from the beverage. This phenomenon may be explained on the basis of “flow-coupling,” where the passage of one permeant is coupled with the direction and rate of diffusion of another permeant. Alcohol reduction processes requiring water exchange or alternative means of reconstitution can thus be expected to alter the flavor/aroma profiles and incorporate anomalous organoleptic qualities to the beverage. Another consideration is that the water used for predilution or reconstitution must be thoroughly purified so that foreign materials or impurities are not introduced into the beverage.

Evaporation and Conventional Pervaportion Methods

Excess alcohol may also be removed from a beverage by evaporation. For example, light beer may be produced by boiling regular beer for a number of hours to drive off much of the alcohol. Hoynup, “Beer”, in Kirk-Othmer Encylopedia of Chemical Technology, Vol. 3, pp. 692-735 (3rd Ed. 1978). Such protracted heating of wine would degrade many of the constituents that contribute to its flavor, color and bouquet. With beer, flavor that is lost by boiling may be restored to some degree by the addition of aroma substances recovered from yeast (German Patent No. 1,767,040), but there is no such simple remedy for the restoration of flavor to thermally damaged wine.

The boiling of beer to remove alcohol also causes a substantial loss of water. That poses no problem for beer because it can simply be reconstituted by the addition of replacement water. Dilution of wine with make-up water, however, is restricted or prohibited by the U.S. Bureau of Alcohol, Tobacco, and Firearms and in most foreign countries. See 49 Fed. Reg. 37510-37530, (Sep. 24, 1984). Other methods for producing low-alcohol beer that also cause the removal of water, such as vacuum distillation and reverse osmosis, may not be applicable to wine because of this. Where the ethanol content of distilled spirits such as whiskeys is reduced by dilution with water, the product must be labeled as “diluted,” and this is undesirable from a marketing standpoint.

Efforts have been made to produce low ethanol wine through flash evaporation (Boucher, U.S. Pat. No. 4,405,652, 1984). The beverage is heated and passed rapidly through a centrifugal evaporator under partial vacuum where the ethanol is vaporized and removed. The drawback of this process is that it does not discriminate between ethanol and other volatile components in the beverage; aroma components in particular are depleted together with the ethanol. In addition, even brief exposure of wines to superambient temperatures of about 30° C. and above can degrade certain flavor and aroma components or caramelize sugars in those beverages. The resultant burnt taste is distinct and objectionable.

Pervaporation can best be described as membrane-mediated evaporation (Mulder et al., 1983, J. Membrane Sci. 16: 269-284 and Neel and Aptel, 1982, Entropie No. 104: 15-40 and Daicel Chemical Co., Japan Patent No. 60-106504, issued Dec. 6, 1985). A solution is fed to one side of a membrane. Selected volatile components in the solution diffuse across the membrane to the permeate side which is evacuated or continuously swept with an inert, non-condensable gas stream. The volatile permeants are removed by evaporation. Selectivity in pervaporation is governed by the permselectivity of the membrane and not the relative volatility of the components. For this reason, pervaporation can accomplish selective removal of ethanol over other volatile components if a membrane permselective toward ethanol is used. In conventional implementations of pervaporation, a hydrophobic membrane with low water permeability is used to limit water loss. The result is significant loss of volatile congeners given their significant solubilization in, and permeation across, the non-polar polymer membrane. Using a hydrophilic membrane instead of a hydrophobic membrane would help preserve the volatile, relatively non-polar congeners in the feed beverage, but the consequent water loss would introduce problems similar to those with reverse osmosis. As discussed supra, loss of volatile flavor components is frequently observed when water is removed from the beverage. Basically, membrane materials with good ethanol permeability also exhibit some water permeability because of the chemical similarities of those two permeants, so the water-barrier property of those membranes is necessarily compromised.

Membrane Extraction

A detailed method of extracting ethanol from beer will now be set forth. Again, it should be noted that the present invention is not limited to such method, and any brewery techniques may be employed per the desires of the user.

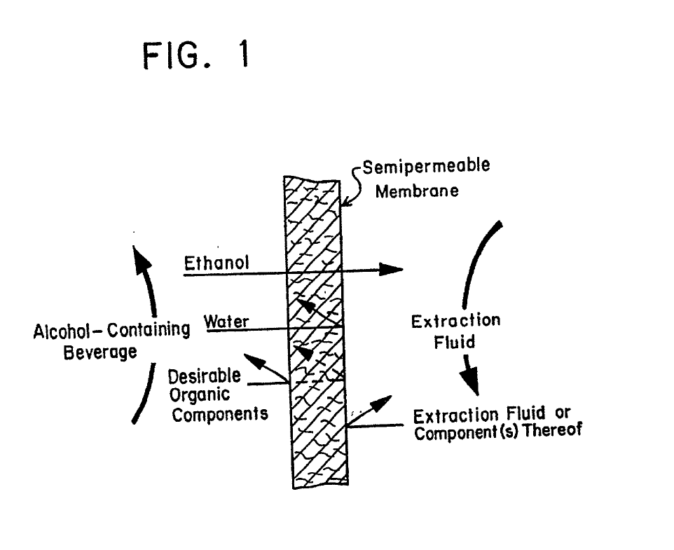

The present embodiment pertains to the selective removal of ethanol by extraction from alcoholic beverages while simultaneously preserving the congener and water contents originally present in the beverage. Each of the problems identified above with existing technologies has been addressed by the process described herein. Removal of ethanol by extraction is illustrated in FIG. 1. As shown, a semipermeable membrane is interposed at the interface between the alcoholic beverage that is to be processed and an appropriate gaseous extraction fluid. Certain desirable organic components or congeners of the beverage are unable to pass through the permselective membrane and into the extraction fluid; additionally, the extraction fluid itself may exhibit a degree of selectivity for the preferential volatilization of ethanol over the other, desirable organic components. In this manner, preferential removal of ethanol over other desirable organic solutes in the beverage is realized.

A second aspect of the present embodiment is its ability to selectively remove ethanol in preference to water. A distinguishing feature of this embodiment is that the membrane need not be selectively permeable to ethanol over water. Indeed, the overall process can exhibit remarkable ethanol/water removal selectivity, even when water would normally be capable of freely permeating the membrane along with ethanol. This performance results from the characteristics of the extraction fluid. In particular, the extraction fluid is chosen such that it does not absorb permeated water from the wine or other alcoholic beverage being treated, nor does the extraction fluid donate water to the alcoholic beverage.

The present embodiment provides a method for producing from a first alcoholic beverage a second beverage of reduced alcoholic content comprising the steps:

1. providing a membrane which is alcohol permeable;

2. feeding a first alcoholic beverage across a feed side of said membrane;

3. feeding a gas-phase extraction fluid across a permeate side of said membrane, said extraction fluid being alcohol absorbing, but substantially not water absorbing and said extraction fluid comprising water vapor in an amount sufficient to minimize the diffusion of water from said first alcoholic beverage to said permeate side of said membrane by balancing the activity of water on said feed side of said membrane so as to evaporate into said gas-phase extraction fluid the portion of the alcohol initially present in said first alcoholic beverage which has crossed to the permeate side of said membrane, thereby forming from said first alcoholic beverage a second beverage having reduced alcoholic content; and

4. withdrawing said gas-phase extraction fluid containing water vapor and alcohol from said permeate side of said membrane, whereby said second beverage having reduced alcoholic content is produced on said feed side of said membrane.

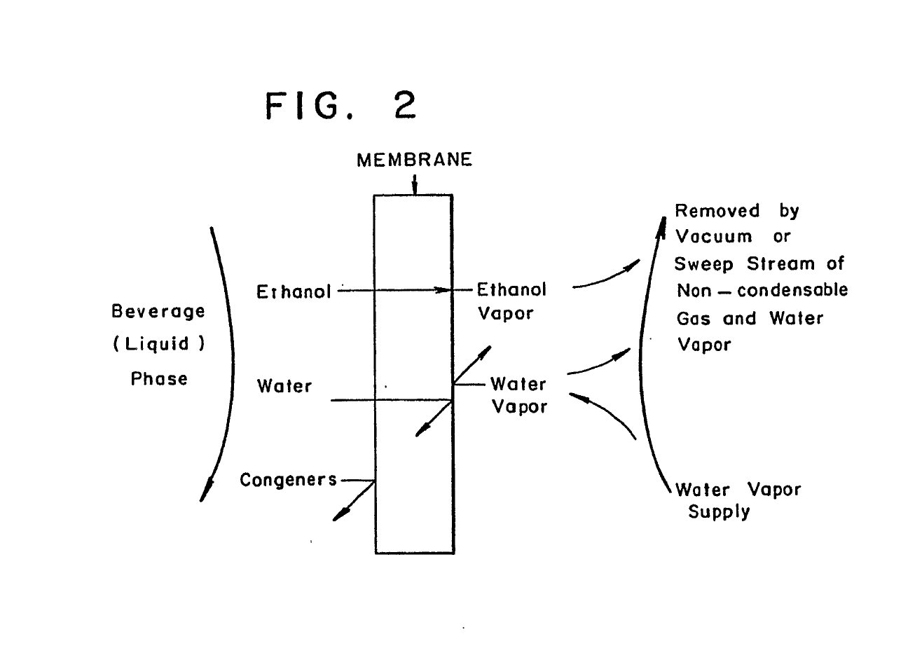

The features of the process are depicted conceptually in FIG. 2. The use of a membrane that is more permeable to ethanol than to the congeners ensures that most of the congeners will be retained in the beverage during ethanol removal. The gas-phase extraction fluid may be maintained in the gas-phase using either a noncondensable gas (e.g. air or nitrogen) or vacuum applied from a vacuum pump. The gas-phase extraction fluid further comprises water vapor to balance the water activities on the permeate and feed sides of the membrane, as will be discussed infra.

The gas-phase extraction fluid may also comprise organic or inorganic components so as to prevent the permeation of such components present in the beverage across the membrane. These components may be naturally in the extraction fluid or they may be selectively added hereto. Although the present embodiment is primarily intended for ethanol removal from beverages, the process concept described herein can be applied generically to the selective removal of one or more volatile components from aqueous solutions while retaining other dissolved components.

The present embodiment provides for equalizing the permeate-side water activity in the gas-phase and the feedside water activity in the liquid phase. In so doing, the driving force for diffusional water transport is nullified, and any exchange of the water originally present in the beverage becomes unnecessary.

It should be noted that the terms “equalization” and “equalize” as used herein to describe the relationship of water activities on opposite sides of the membrane is meant to describe four cases: (i) where the water activities on opposite sides of the membrane are precisely identical; (ii) where the water activities on opposite sides of the membrane are approximately the same—i.e., not precisely equal, but roughly in balance; (iii) where the water activities on opposite sides of the membrane are not everywhere equal, but where the deviations from equality of water activities that exist at different points along the membrane surface are largely compensatory (i.e., positive deviations being compensated for by negative deviations) with the result that there is little or no overall flux of water into or from the alcoholic beverage being treated; and (iv) where the water activities on opposite sides of the membrane are not equal at all times during the alcohol removal process, but where the deviations from equality of water activities that exist at different times are largely compensatory with the result that there is no overall flux of water into or from the alcoholic beverage being treated. Ultimately, it is the quality of the treated beverage that is the determinant of how closely the ideal of perfect equality of transmembrane water activities must be approached in the practice of the process of this embodiment.

In order that there be no water transport across the membrane, the activities of water in the liquid and gas-phase extraction fluid should be equivalent. In other words, there should be no driving force for water in one direction or the other. For this to be achieved, the chemical potential of water in the liquid and gas-phase extraction fluid should be equivalent.

It should be noted that the activity of a substance in the gaseous or liquid phase is the ratio of the fugacity of the substance at a given temperature T to the fugacity of the substance in the standard state. Therefore, if the fugacity of water in its liquid and gas state are equivalent, it follows that the activities are also equivalent. For more information regarding such, reference may be made to U.S. Pat. No. 5,013,436, which is incorporated herein by reference.

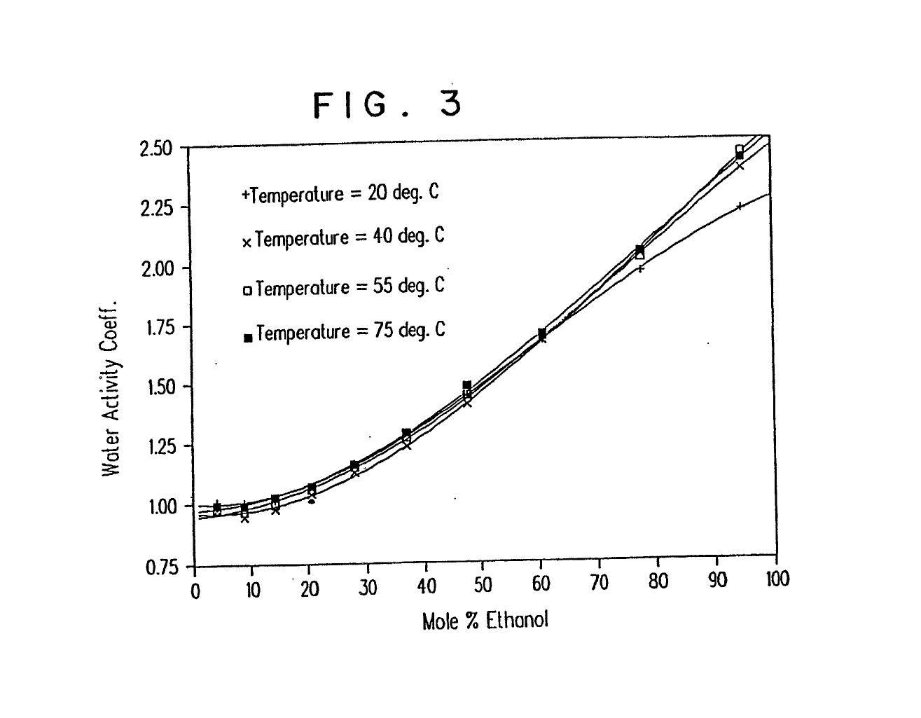

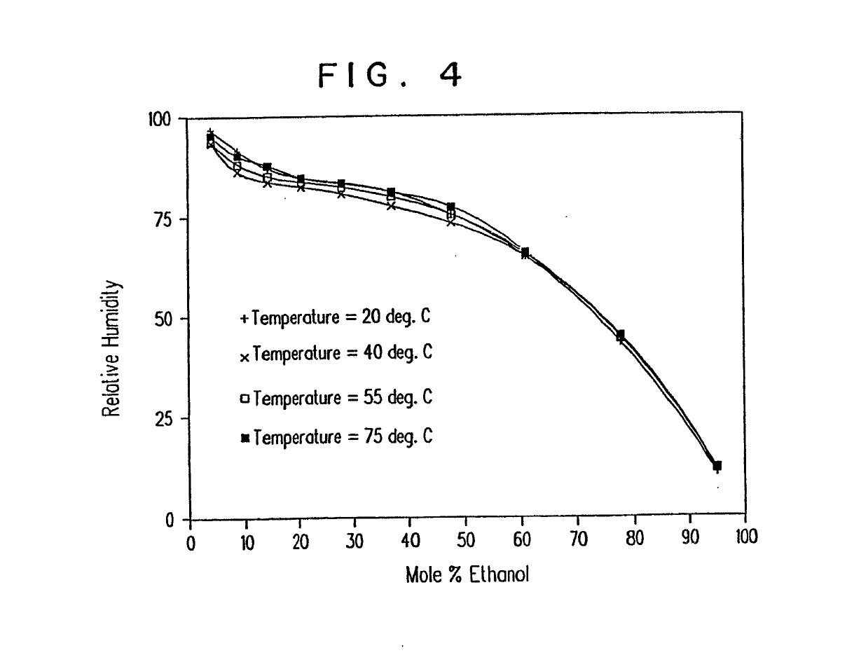

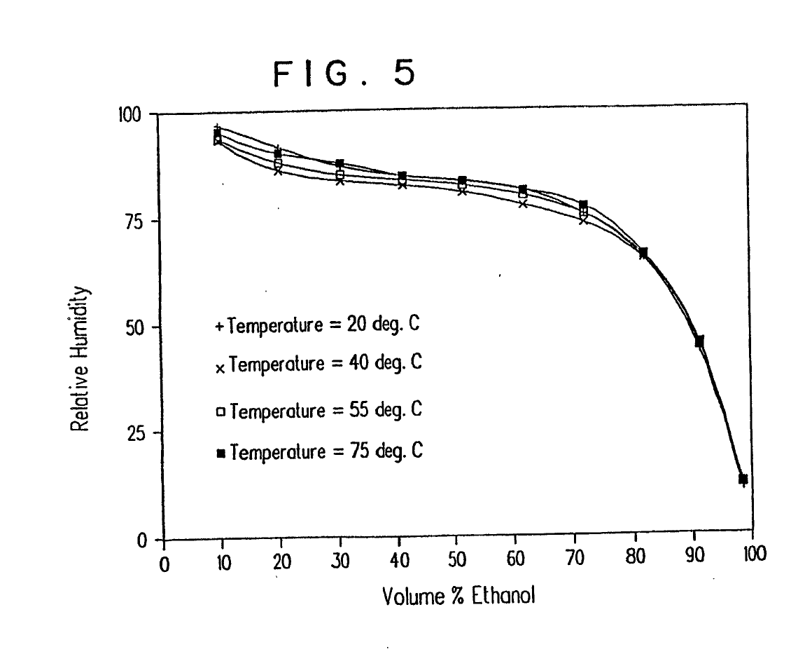

FIG. 3 shows activity coefficient of water vs. mole fraction of ethanol in an aqueous phase. The relative humidity required to prevent water transport across the membrane as a function of mole % ethanol and as a function of vol % ethanol in the liquid stream is plotted in FIGS. 4 and 5 respectively.

Commercially available alcoholic beverages which include but are not limited to beer, wine, brandy and distilled spirits have an initial ethanol content of from about 5 to about 75 volume %. Correspondingly, the relative humidity should be maintained at about 60 to about 95% at about 5° C. to about 75° C. Specifically, if the alcoholic beverage is a beer with an initial ethanol content of from about 5to about 10% by volume, the relative humidity should be maintained at about 95% to about 100% at about 5° C. to about 75° C. If the alcoholic beverage is a wine with an initial ethanol content from about 9 to about 13% volume, the relative humidity should be maintained at about 85 to 95% at about 5° to about 75° C. If the alcoholic beverage is a brandy with an initial ethanol content from about 35 to about 55 volume %, the relative humidity should be maintained at about 80 to 90% at about 20° to about 75° C. If the alcoholic beverage is a distilled spirit with an initial ethanol content from about 50 to about 70 volume %, the relative humidity should be maintained at about 75 to about 85% at about 20° C. to about 75° C. In some cases, processing temperatures below about 20° C. or above about 75° C. may be desirable. The same principle of relative humidity adjustment applies generally at those other temperatures.

A variety of process schemes are possible for equalizing feed- and permeate-side water activities in pervaporation. The present embodiment also relates to an apparatus for producing from a first alcoholic beverage a second beverage of reduced alcoholic content comprising

1. a membrane which is alcohol permeable;

2. means for feeding a first alcoholic beverage across a feed side of said membrane; and

3. means for providing a gas-phase extraction fluid to a permeate side of said membrane;

4. means for regulating the relative humidity of said gas-phase extraction fluid on said second side of said membrane; and

5. whereby alcohol diffuses from the first beverage through the membrane into said gas-phase extraction fluid to produce said second beverage on the first side of said membrane having reduced alcohol content and a gas-phase extraction fluid comprising water vapor and alcohol on the second side of said membrane. Example embodiments of the technology are described below. It is assumed in all cases that relatively polar, hydrophilic membranes with good ethanol/congener selectivity are used.

Vapor Swept Systems

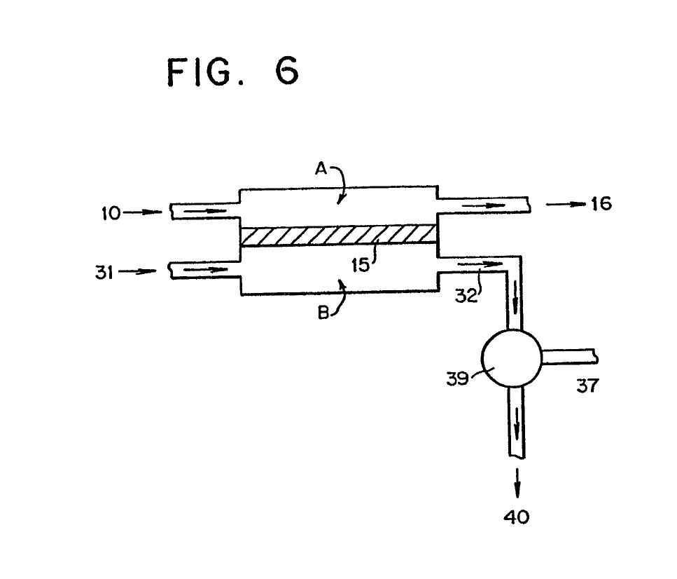

A preferred vapor-swept pervaporation system embodying the water activity management concept is shown conceptually in FIG. 6. A membrane unit comprises two flow compartments, one on each side of the membrane 15. Beverage 10 is fed to compartment A of the membrane unit, a gas-phase extraction fluid 31 comprising a mixture of non-condensable gas (such as air or nitrogen) and water vapor is fed to the other compartment B as a sweep stream. A feed subsystem regulates the delivery rate and the temperature of the beverage; it also replenishes the latent heat of evaporation lost from the feed stream during ethanol pervaporation. A humidification subsystem is used to regulate the temperature, relative humidity (and thus activity), and flow rate of the sweep stream. The beverage emerges with a reduced alcoholic content 16. An alcohol recovery subsystem 39 separates the water and ethanol 40 from the non-condensable gas 37 in the gas-phase extraction fluid that emerges 32. Provided that the sweep stream flow rate is sufficiently high to prevent excess ethanol accumulation on the permeate side of the membrane, the pervaporation and purging actions will continue to sustain ethanol reduction. Another function of the sweep stream is to help supply part of the latent heat of ethanol evaporation.

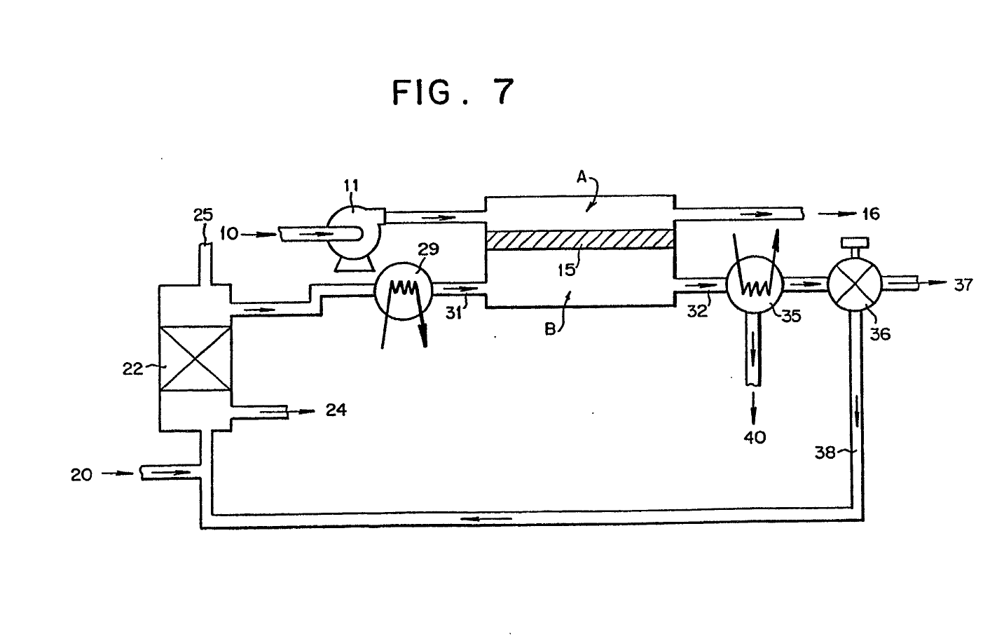

Another preferred embodiment of the humidification subsystem is shown in FIG. 7. The beverage 10 is circulated via a pump 11 to compartment A of the membrane unit containing membrane 15. The beverage emerges with a reduced alcoholic content 16. Liquid water 25 is vaporized into the non-condensable gas 20 in a gas liquid contactor 22 (e.g. a spray tower, packed column, etc.). Excess water may be removed via an outlet 24. The temperature Tₛ inside the contactor 22 (approximately equal to that of the incoming water) is set to produce a water loading of the gas which, upon heating with a process heater 29 to the operating temperature T of the resulting gas-phase extraction fluid 31, will give exactly the desired relative humidity. The process heater may be for example a steam or electrical heater, a heat exchanger, or some other heat source operated at a temperature sufficiently high to give the desired relative humidity. The gas-phase extraction fluid that emerges from compartment B of the membrane unit, comprising non-condensable gas, water vapor, ethanol vapor, and other volatile organic components (e.g. congeners) 32 may be cooled with a condenser 35 and the liquefied ethanol solution 40 may be collected. The non-condensable gas, stripped of water and ethanol vapors, can be vented 37 via a valve 36 or recycled 38 to the humidification system. Recycling is desirable in some cases. For example, nitrogen may be used as the non-condensable gas for the purpose of minimizing oxidation of the beverage; but disposal of the gas after a single pass through the membrane unit would be uneconomical. Another reason for recycling is to allow certain permeated congeners to accumulate in the gas stream so as to deter further loss of those congeners from the beverage. Optionally, the temperature and flow rate of the incoming non-condensable gas stream may be adjusted so that the gas does not become saturated with water vapor in the liquid-gas contactor, rather, the exiting gas stream would have the required temperature and relative humidity with no further heating or cooling.

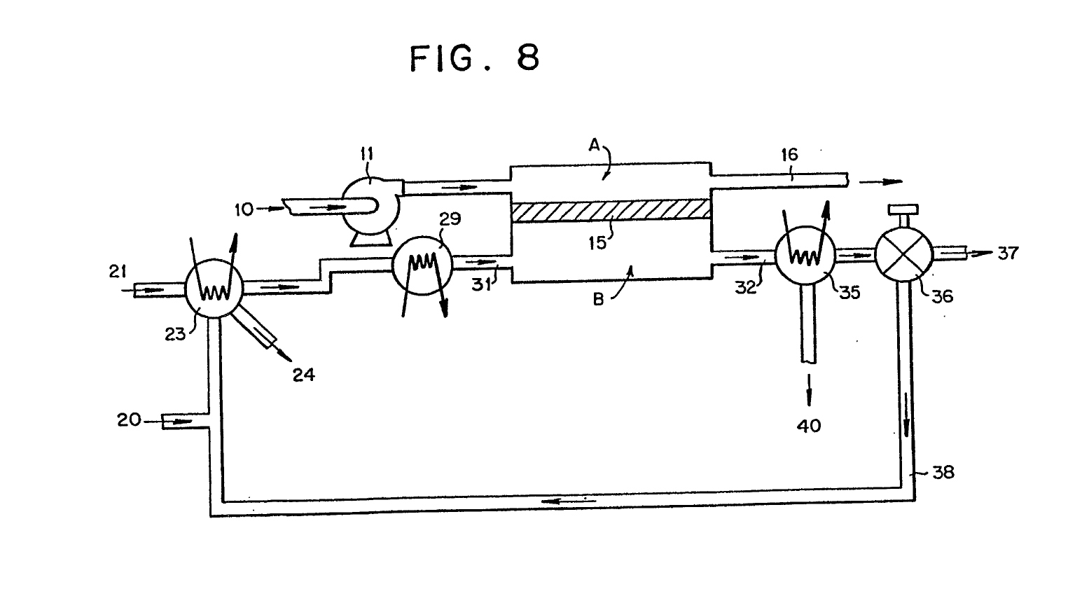

Another preferred embodiment is shown in FIG. 8. As in FIG. 7, the beverage 10 is circulated via a pump 11 to compartment A of the membrane unit containing membrane 15. The beverage emerges with a reduced alcoholic content 16. Steam 21 is mixed with the non-condensable gas 20 in a condenser 23 to produce a watersaturated gas-phase extraction fluid at Tₛ. Excess water condensed from the steam 24 is removed from the condenser 23. Again, the gas-phase extraction fluid is heated to temperature with a process heater 29 to produce a gas-phase extraction fluid 31 having the desired relative humidity. Optionally, injection of steam at a precisely controlled rate into a pre-conditioned air stream may be feasible as a means of generating the desired humidified air sweep stream in a single step. The condenser 23 in this case would function as a mixing chamber for air and steam and no reheater would be required. As described for FIG. 7, the gas-phase extraction fluid that emerges 32 from compartment B of the membrane unit may be cooled with a condenser 35 and the liquefied ethanol solution 40 may be collected. The non-condensable gas may be vented 37 via a valve 36 or recycled 38 to the humidification system.

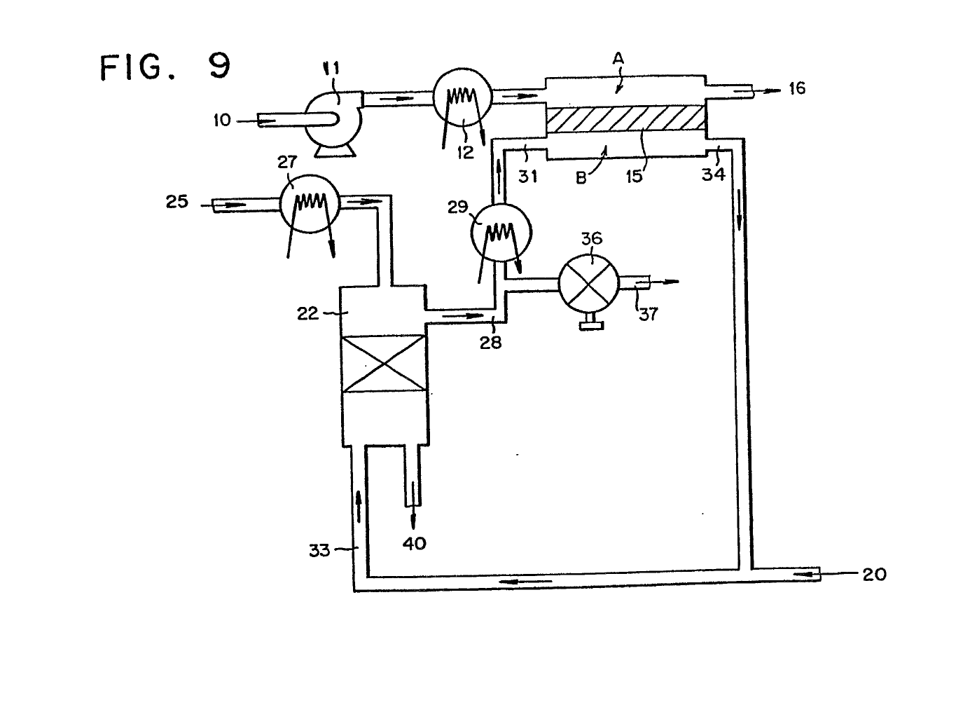

Yet another preferred embodiment of the present embodiment combines the humidification and ethanol recovery subsystems in the form of a gas-liquid contactor. A schematic diagram of such a process is shown in FIG. 9. As described in FIGS. 7 and 8, beverage 10 is circulated via a pump 11 to compartment A of the membrane unit containing membrane 15 to produce a beverage of reduced alcoholic content 16. In this embodiment, the alcoholic beverage is heated to the operating temperature with a process heater 12. As in FIGS. 7 and 8, an alcohol reduced beverage 16 is produced. Liquid water 25 which is heated by the process heater 27 enters the gas-liquid contactor 22 where it is vaporized into the non-condensable gas-phase extraction fluid 33. The gas-phase extraction fluid may comprise fresh non-condensable gas 20 and recycled gas-phase extraction fluid 34 that has passed through compartment B of the membrane unit. The contactor strips the ethanol from the gas-phase extraction fluid 33 entering the gas-liquid contactor, to produce an ethanol-water mixture 40 and simultaneously resaturates the gas-phase extraction fluid 28 at temperature T_{S}. A process heater 29 then raises the temperature of the gas-phase extraction fluid 31 that enters the membrane unit to the operating temperature T. Alternatively some of the humidified non-condensable gas may be vented 37 via a valve 36.

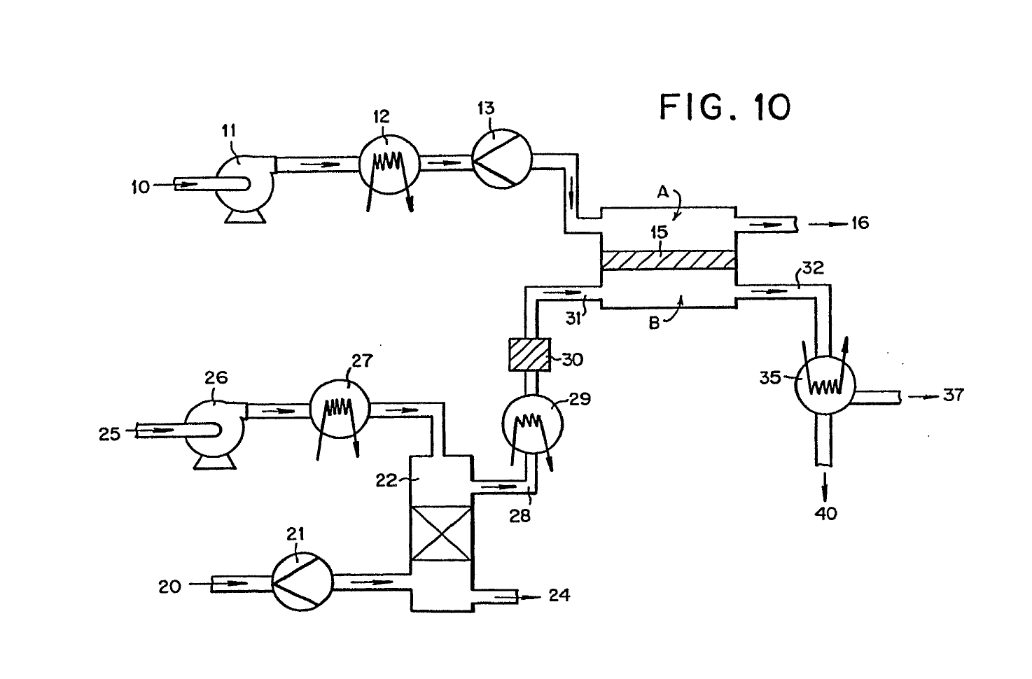

In another preferred embodiment, as shown in FIG. 10, the alcoholic beverage 10 is circulated with a pump 11 to compartment A of the membrane unit containing membrane 15. A process heater 12 may be used to maintain the feed stream at an operating temperature T. A flowmeter 13 may be used to adjust the flow rate of the beverage stream. The gas-phase extraction fluid 31, supplied to compartment B of the membrane unit may be produced by pumping air 20 through a separate column 22 where it contacts water 25 heated with a process heater 27 at a temperature T_{S} to reach saturation. A flowmeter 21 may be used to monitor the flow rate of the air, 20. A pump 26 may be used to control the flow rate of the water. Excess water may be removed via an outlet 24. The saturated gas-phase extraction fluid 28 may then be reheated with a process heater 29 to the operating temperature T to attain a relative humidity governed by the temperature rise (T-T_{S}). T_{S} may be determined from a given T and the required relative humidity by using the procedure shown in FIG. 3 or 4, and using the disclosure of U.S. Pat. No. 5,013,436. Equalizing the temperature of the feed and sweep streams, although optional, may help maintain a uniform relative humidity along the permeate side of the membrane by reducing transmembrane heat transfer beyond that associated with pervaporation of ethanol. The apparatus may be equipped with an automatic humidity control system 30 that monitors the relative humidity of the gas-phase extraction fluid 31 at the entrance to the membrane module, and adjusts the saturation temperature, Tₛ to compensate for deviations from the relative humidity set point. The gas-phase extraction fluid 32 exiting from the membrane module is sent to a condenser 35 where water and the pervaporated ethanol 40 are liquefied and collected. A thin-film composite membrane comprising an interfacially crosslinked polyurea membrane supported by an asymmetric, microporous polysulfone substrate is preferred.

Vacuum Systems

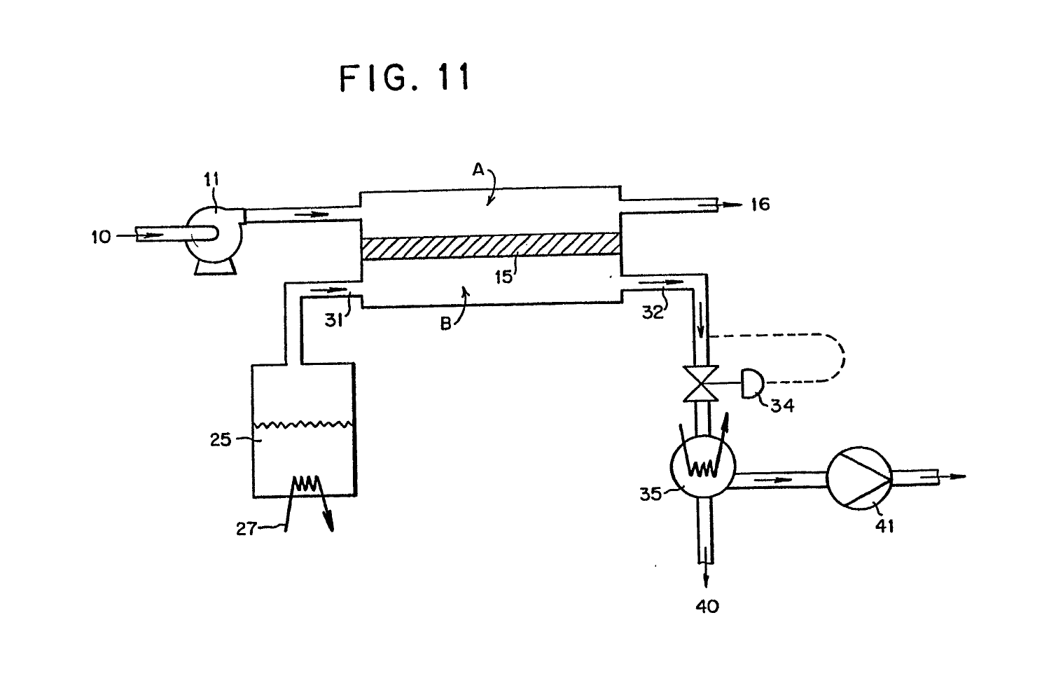

A pervaporation system embodying the water-activity equalization concept but which uses vacuum to remove the permeate is depicted to FIG. 11. Beverage 10 is fed into compartment A of the membrane unit containing membrane 15 via a pump 11 to produce a beverage of reduced alcoholic content 16. The inlet to the permeate side of the membrane unit is connected to a water reservoir 25 equipped with a heater 27. Compartment B of the membrane unit is connected, sequentially to a back-pressure regulator 34, a condenser 35, and a vacuum pump 41. This arrangement is used to regulate water vapor supply to the gas-phase extraction fluid 31 entering the permeate side of the membrane while continuously removing the pervaporated ethanol from the emerging gas-phase extraction fluid 32. To obtain a water activity less than unity, the water vapor is supplied at a partial pressure lower than its vapor pressure at that temperature. This is accomplished by adjusting the back-pressure regulator 34 to open whenever the permeate-side pressure is in excess of the target partial pressure. Ethanol and water vapors 40 released through the back-pressure regulator 34 may be condensed and recovered.

Membranes

The membranes used in the methods of the present embodiment must have a high ethanol/congener selectivity when ethanol is removed by extraction with gas-phase extraction fluids. Specifically, the membranes should be highly permeable to ethanol and be permselective between ethanol and other organic components of the beverage. Bearing these limitations in mind, a number of types of membranes have potential applicability in this embodiment, and the choice will be influenced by economic considerations, the ethanol compatibility of the membrane, and its availability in high-surface-area configurations. For example, membranes constructed of crosslinked or uncrosslinked polymeric materials or more loosely organized elastomeric materials are suitable. Membranes that are now used for reverse osmosis (RO) are good candidates for use in this embodiment, because RO applications entail high transmembrane water fluxes of polar permeants (e.g., water).

Membranes that permit rapid water permeation usually will be significantly permeable to ethanol as well.

Membranes which exhibit ethanol fluxes adequate for the present embodiment should be thin, nonporous, and may be derived from polymers that are crosslinked or uncrosslinked, glassy or rubbery, and water-swollen to various degrees. In tests, ethanol fluxes ranging from about 0.04 to 0.09 mL/cm²-hr have been observed with a thin-film-composite crosslinked polyurea membrane, depending on the ethanol concentration in the feed beverage.

The literature contains numerous references to membranes of varied compositions and structures. In general, membranes that are relatively hydrophilic (i.e. exhibiting higher permeabilities to water and ethanol than to higher alcohols) with fluxes comparable to those mentioned above should be suitable from a productivity standpoint.

Overall, a number of membrane types may be useful for the selective removal of ethanol from alcoholic beverages, including but not limited to various aliphatic and aromatic polyamides, polyureas, polyetherureas, polyimides, polyoxazolines, polyetheraminotriazine, regenerated cellulose, cellulose acetate, cellulose triacetate, crosslinked polyvinyl alcohol, polyacrylonitrile and its copolymers (these polymers being particularly resistant to ethanol swelling), polybenzimidazole, and polybenzimidazolone, hydrophilic crosslinked vinyl polymers and copolymers, and ion-exchange membranes with various counterions.

Any membrane geometry is potentially applicable. In one embodiment, a hollow-fiber module with high membrane area-to-module volume ratio is used. The flow of alcoholic beverage may be directed through the lumen of the hollow fibers and the gas-phase extraction fluid along the exterior shell of the fibers, or vice versa. The preferred configuration will depend on the pressure capability, wettability, and porosity of the fibers, as well as on the hydrodynamic and mass transfer characteristics of the modules containing them. The preferred operating pressures of the process depend on the specific embodiment. With humidified non-condensable gas as the sweep stream, the preferred gas stream pressure would be at 1 atm, or fractionally above 1 atm consistent with membrane module and piping pressure drops. The beverage stream will similarly be held at or about 1 atm to minimize the transmembrane pressure. Where vacuum operation is the preferred method of removing the pervaporated ethanol, then the permeate side of the membrane will be maintained at subatmospheric pressures.

Preferred Energy Enhanced Embodiment

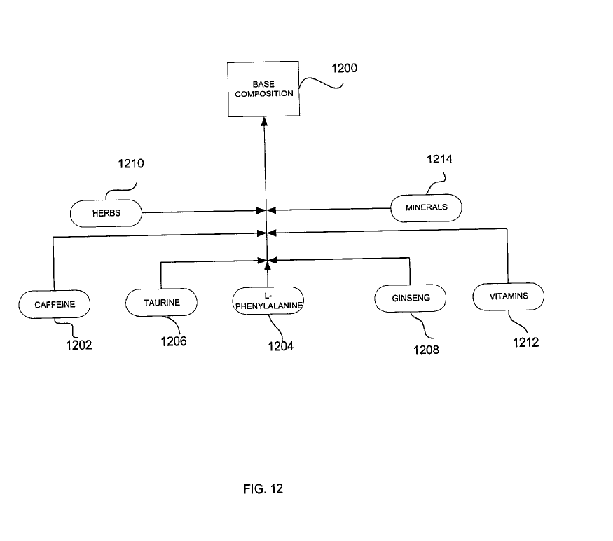

FIG. 12 illustrates a composition capable of providing increased energy. First included is a base composition 1200 of any desired fluid. For example, water, juice, malt beverage (i.e. beer), or the like may be employed. It should be noted, however, that any desired base composition may be utilized per the desires of the user. Further, such base composition may be generated using any desired method.

In one embodiment, a non-alcoholic beer may be utilized. Such base composition may be manufactured using any of the techniques set forth hereinabove, any desired undisclosed techniques, or a combination thereof. Ideally, the non-alcoholic beer base composition will be initially elaborated as a malt beverage with less than 0.5% Alcohol by Volume, so as to be denominated a Non-alcoholic Beer. It should be noted that any other percentage of alcohol may be used to comply with state or federal laws.

Once the base composition 1200 is provided, special ingredient(s) may then be incorporated into the liquid in such quantities and relative proportions that help enhance the body's alertness and energy sensation, but do not alter the organoleptic characteristics of the base composition 1200. In the case of non-alcoholic beer, such organoleptic characteristics may include taste, color, smell, body and foam. The ingredients preferably include energy-enhancing ingredients for providing increased energy.

In one embodiment of the present invention, the energy-enhancing ingredients may include an alkaloid. Such alkaloid may include caffeine 1202. In another embodiment of the present invention, the energy-enhancing ingredients may include an aminoacid such as L-phenylalanine 1204, taurine 1206, or the like. Still yet, the energy-enhancing ingredient may include ginseng 1208, herbs 1210, vitamins 1212, minerals 1214, and the like for enhancing the base composition.

It should be noted that any combination of the foregoing ingredients may be used as energy-enhancing ingredients, as well as ingredients not listed but provide energy enhancement. Additional information regarding the foregoing ingredients will now be set forth.

Alkaloids

Caffeine is an alkaloid obtained from the leaves and seeds of the Coffea arabica or coffee plant and from the leaves of Thea sinensis or tea. Caffeine is a methylated xanthine having the formula C₈H₁₀N₄O₂, is anhydrous and has a molecular weight of 194,19. The solubility of methyl xanthine is low. In accordance with the invention a mixture of caffeine and PABA the latter for increasing the solubility of the caffeine (methyl xanthine) is preferred. Such mixture contains anhydrous caffeine and about equal amounts of solubilizer, (PABA) and is freely soluble in water and alcohol.

Although caffeine occurs naturally, it is prepared synthetically for commercial drug use. Both forms are equally suitable for use herein.

The known pharmacologic actions of caffeine include: (1) the relaxation of smooth muscle, notably bronchial muscle and the stimulation of voluntary skeletal muscle, increasing the force of contraction and decreasing associated muscular fatigue, (2) caffeine stimulates all levels of the central nervous system. In oral doses of 100-200 mg, the drug stimulates the cerebral cortex producing a more rapid and clearer though flow, wakefulness, or arousal in fatigued patients and improved psychomotor coordination as well as increased capability for sustained intellectual effort and decreased reaction time, and (3) action on the kidney to produce diuresis.

Caffeine is essentially non-toxic. The FDA has indicated that no fatal caffeine poisoning has ever been reported as the result of an overdose of this compound. The short term lethal dose of caffeine in adults is 5-10 grams. At moderate doses, caffeine poses little or no risk of developmental toxicity for the human fetus. These is no evidence that consumption of caffeine is causally related to the development of cancer or increased incidence of coronary heart disease.

Caffeine is readily absorbed after oral, rectal or parental administration. Maximal plasma concentrations are achieved within 1 hour. Caffeine has a half-life in plasma of 3-7 hours.

Caffeine is the only over-the-counter stimulant that meets the FDA standards for stimulants. The FDA has concurred that caffeine is both safe and effective. The recommended dose is 100-200 mg not to be administered more often than every 3 or 4 hours. The FDA has noted that, in contrast to the irritating qualities of many coffee extracts, caffeine itself, does not cause irritation of the gastro-intestinal tract in the usual doses. This is an advantage when the drug is used for its stimulant properties. The FDA, in its publications has stated that the evidence establishes that caffeine restores alertness when a person is drowsy or fatigued.

Aminoacid

Taurine

Taurine (2-aminoethanesulfonic acid, NH₂CH₂CH₂SO₃H) is a betasulfonic acid present in high concentrations in animal cells. Taurine and its related compounds, such as hypotaurine (2-aminoethanesulfinic acid) and isethionic acid (2-hydroxyethanesulfonic acid) are formed in animal tissue and vary in concentration from species to species and among tissues. Little, if any, taurine is found in plants.

Additionally, platelets and lymphocytes are found to have present large concentrations of taurine, ranging up to about 50% of the total pool of free amino acids present in these cells. The physiological function of taurine remains unclear, although it is clear that it is an important amino acid for maximal cell viability and homeostasis. Additionally, at least one investigator has termed taurine a “conditionally essential nutrient” meaning that, although the nutrient is not essential for normal subjects, certain individuals, having lost the ability to conserve the compound or having increased requirements due to illness or for other reasons, must supplement their diets with taurine to maintain normal health. Chipponi et al, Am. J. Clin. Nut., 35, (May 1982), pp. 1112-1116; Jacobsen and Smith, Phys. Rev. v. 48, No. 2, (April 1968), pp. 424-511.

The cells of many species possess considerable ability to synthesize taurine, although this is not the case with primates, including man. Certain animals including primates and man have very limited ability to synthesize the amino acid, and rely on diet to maintain taurine stores.

Human B-lymphoblastoid cells take up taurine present in physiological concentrations in plasma, using an active uptake system. These same cells take up taurine when cultured in media supplemented with serum, and show progressive depletion of taurine when cultivated in chemically defined, taurine free media. Taurine exhibits a positive effect on the number of viable cells in a culture when added to a taurine free medium used in such a culture. Evidence is available which supports the hypothesis that taurine mediates protective action on cell membranes which lead to an increase in cell viability. Huxtable and Bressler, Biochem et Biophys. Acta., 323 (1973), pp. 573-583.

Retinols, the major components of vitamin A, and the related compounds, retinoids, are well known as inhibitors of cell growth. These compounds interact directly with membranes causing increases in permeability and fluidity, and destabilize biological membranes, Stillwell and Bryant, Biochim et Biophys. Acta, 731 (1983) 483-486. This results in hemolysis in erythrocytes, and in increased enzyme secretion in lysosomes. Additionally, when retinols are incorporated into lipid bilayers of liposomes, these are made more permeable to cations and to larger molecules, such as glycine, lysine and glucose. The increase in permeability is often accompanied by decreases in phase temperatures of the liposomes, as well as electrical resistance of the membranes.

Ascorbic acid, i.e. vitamin C, and the related ascorbates, in systems with iron compounds, are known to induce lipid peroxidation of cell membranes, see, e.g. Lewis, Biochem. Pharm. v. 33, No. 11, pp. 1705-14 (1984). The damage that results from this peroxidation is often accompanied by increased membrane permeability, and enhanced water accumulation. When either retinols or iron-ascorbate systems are present, cell viability is decreased due to membrane interference caused by the presence of these, Stillwell and Bryant, op. Cit.; Lewis, op. Cit.

Each of these, i.e. vitamin A (retinol), vitamin C (ascorbic acid or ascorbate), and iron compounds is a necessary nutrient for humans. Hence, removal of these substances from the diet is not possible. In fact, each of these substances may be taken not only through natural occurrence in comestibles, but also through vitamin and mineral nutritional supplements. These supplements are available in a variety of formulations, and often contain well in excess of the amount of each substance necessary for proper nutrition, even when suggested doses are taken. Many who take vitamin supplements, however, believe that increased consumption of these supplements will result in increased beneficial effects. Actually, such increased consumption may lead to increased risk of cell damage, as set forth herein.

Taurine and its physiologically acceptable derivatives have been shown to have a positive effect on cell viability, see, e.g. Alvarez and Storey, Biol. Reprod., 29, 548-555 (1983). Evidence supports the view that taurine mediates a protective effect on cell membranes. Zinc has been shown to exhibit a protective effect on cell membranes as well.

Vitamin E, or tocopherol, is known as having positive effects in counteracting membrane destabilizing actions of retinoids, Stillwell and Bryant, op. Cit.; I. Gery, Inv. Ophthal & Vis. Sci. v. 19 (December 1980) pp. 751-759.

L-phenylalanine

The L-phenylalanine is an essential amino acid for humans and a raw material for production of aspartame, an artificial sweeter. The main industrial processes for phenylalanine production are enzymatic conversions and microbial fermentations. Because it is difficult to get the raw material for the enzymatic conversion, and the cost of the raw material changes significantly from time to time. Thus, the industries prefer to utilize microbial fermentations for phenylalanine production. Fed-batch operation is the most popular fermentation process, since it gives higher productivity than batch fermentationidoes, and it can also get rid of the high contamination problem of the continuous culture. However, as phenylalanine fermentation (see the work of Wang P.-M. et al, 1994, Biotechnology Techniques, V. 8 No. 11, November) was carried out by Corynebacterium qlutamicum, the product feedback inhibition by phenylalanine is still present. Besides, no work has mentioned the influence of oxygen supply rate on the product feedback inhibition of phenylalanine formation. The present inventions designs experiments to study the effect of oxygen supply rate on product feedback inhibition, and provides process control methods to decreases product feedback inhibition by proper increases of oxygen supply.

Some previous work in literature used phenylalanine resistant analogues such as phenylalanine p-fluorophenylalanine (p-FP), m-resistant fluorophenylalanine (m-FP), or aromtic amine analogues such as 3-amino-L-tyrosin (3AT), 5-methyltyryptophan (5 MT) to screen high phenylalanine producing strains. The screened strains possess higher phenylalanine resistant capability, but phenylalanine production by the screened strains were still inhibited by high phenylalanine concentrations.

Manufacturing methods of L-phenylalanine can be classified into a chemical synthesis method, a fermentation method and residual an enzyme method. An example of the enzyme method comprises using cinnamic acid as a starting material and phenylalanine ammonia lyase in the presence of ammonia. This reaction is reversible, and cinnamic acid which is the starting material remains in the reaction solution. Therefore, the remaining cinnamic acid must be removed in a purification step to efficiently collect the L-phenylalanine.

As purification methods for L-phenylalanine, there have been employed a method using an ion exchange resin adsorbent (Japanese Patent Application Laid-open No. 194056/1986), a method using concentration/crystallization (Japanese Patent Application Laid-open No. 133893/1985) and a method using a lower alcohol (U.S. Pat. No. 4731469).

Ginseng

Ginseng has been used for the herb medicine and the enriched nutritious food product is a perennial plant of Alaliacea family having the botanical name of Panax schinseng, which is distributed over a region from the northeastern district of China to Korea and cultivated also in Japan, namely in Shimane prefecture and so on.

The botanical name of “Panax” means the complete healing, namely a cure-all and originates in the PAN (all) and the AKOS (healing) of Greek. This ginseng is effective as the herb medicine for additionally filling up spirits of the main entrails of the liver, the heart, the spleen, the lugs and the kidney.

As substitutes for this ginseng there has been provided Panax japonicaus, Panax quinquefolium or Acanthopanax senticosus of similar kind having the same medicinal effects.

A main ingredient of the ginseng is saponin. As the saponin included in this ginseng there have been known twelve kinds of ginsenside-Ro, -Ra, -Rb1, -Rb2, -Rc, -Rd, Re, -Rf, -Rg1, -Rg2, -Rg3, -Rh. These are the one (ginsenside-Rb1, -Rb2, -Rc) containing sapogenen and protopanaxadiol, and the one (ginsenside-Re, Rf, -Rg1, -Rg2) containing sapogenen and protopanaxatriol. The main saponin in the crude drug is ginsenside-Rb1, -Rb2, -Rc, -Rg1. The ginsenside-Ro is the same as chikusetsusaponin V, and the ginsenside-Rb1 is the same as saponin D.

Besides those, the ginseng contains essential oil of 0.05%, β-elemene, panacene (C₁₅H₂₄) and panaxynol as polyacetylene compound and further contains choline, vitamin B complex, fatty acid and so on.

Ginseng has been highly esteemed as valuable drugs since ancient times and there were conventionally following two methods for preparing raw materials to be used for eniched nutritious food products and herb medicines.

According to the first method, raw ginsengs harvested from fields are washed and then dried by the sun or heating as they are or after having been put through the hot water. According to the second method, raw ginsengs are washed, steamed at temperatures below 130° C. and then dried by heating at 70° C.

Both those preparation methods are used in Japanese markets, and ginseng drugs containing sufficient amount of the above-mentioned ingredients are judged good in quality even though they are prepared in either method.

Then, the ginseng extract is obtained from those prepared raw ginsengs by means of alcohol- or water-extracting method. The ginseng extract is used as it is or in granular state for enriched nutritious food products and herb medicines such as various kinds of drink drugs, tablet drugs or teas.

However, according to either conventional method for preparing such raw material, since the ginseng is to be heated at temperatures above 40° C. at the time of heating or drying, disadvantageously a portion of the saponin of the main ingredient is destroyed.

Further, since the ginseng extract is obtained by extracting only the saponin group, part of the ingredient obtained from the partially destroyed prepared raw material, the extract is lack of useful ingredients inherent to ginseng. Especially other effective ingredients except the saponin ingredients are not utilized effectively at all so far.

That is, conventional, so-called ginseng products have come off largely from the effective ingredients of the raw ginseng harvested from fields.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-alcoholic beer composition capable of providing increased energy, comprising:
(a) a base composition including non-alcoholic beer; and
(b) an energy-enhancing ingredient mixed with the base composition.

2. The non-alcoholic beer composition capable of providing increased energy as recited in claim 1, wherein the energy-enhancing ingredient includes an alkaloid.

3. The non-alcoholic beer composition capable of providing increased energy as recited in claim 2, wherein the alkaloid includes caffeine.

4. The non-alcoholic beer composition capable of providing increased energy as recited in claim 1, wherein the energy-enhancing ingredient includes an aminoacid.

5. The non-alcoholic beer composition capable of providing increased energy as recited in claim 4, wherein the aminoacid includes L-phenylalanine.

6. The non-alcoholic beer composition capable of providing increased energy as recited in claim 4, wherein the aminoacid includes taurine.

7. The non-alcoholic beer composition capable of providing increased energy as recited in claim 1, wherein the energy-enhancing ingredient includes ginseng.

8. The non-alcoholic beer composition capable of providing increased energy as recited in claim 1, wherein the energy-enhancing ingredient includes herbs.

9. The non-alcoholic beer composition capable of providing increased energy as recited in claim 1, wherein the energy-enhancing ingredient includes vitamins.

10. The non-alcoholic beer composition capable of providing increased energy as recited in claim 1, wherein the energy-enhancing ingredient includes minerals.

11. A method for producing a non-alcoholic beer composition capable of providing increased energy, comprising the steps of:
(a) providing a base composition including non-alcoholic beer; and
(b) including an energy-enhancing ingredient with the base composition.

12. The method as recited in claim 11, wherein the energy-enhancing ingredient includes an alkaloid.

13. The method as recited in claim 12, wherein the alkaloid includes caffeine.

14. The method as recited in claim 11, wherein the energy-enhancing ingredient includes an aminoacid.

15. The method as recited in claim 14, wherein the aminoacid includes L-phenylalanine.

16. The method as recited in claim 14, wherein the aminoacid includes taurine.

17. The method as recited in claim 11, wherein the energy-enhancing ingredient includes ginseng.

18. The method as recited in claim 11, wherein the energy-enhancing ingredient includes herbs.

19. The method as recited in claim 11, wherein the energy-enhancing ingredient includes vitamins.

20. The method as recited in claim 11, wherein the energy-enhancing ingredient includes minerals.
